(19) United States
(12) Patent Application Publication
(10) Pub. No.: US 2011/0205981 A1
(43) Pub. Date: Aug. 25, 2011

(54) MULTIPLEXING UPLINK L1/L2 CONTROL AND DATA

(76) Inventors: Changsoo Koo, Melville, NY (US); Kyle Jung-Lin Pan, Smithtown, NY (US); Robert L. Olesen, Huntington, NY (US); Shahrokh Nayeb Nazar, Sainte-Julie (CA); Marian Rudolf, Montreal (CA); Paul Marinier, Brossard (CA)

(21) Appl. No.: 12/854,260

(22) Filed: Aug. 11, 2010

Related U.S. Application Data
(60) Provisional application No. 61/233,747, filed on Aug. 13, 2009.
(60) Provisional application No. 61/356,250, filed on Jun. 18, 2010.

(51) Int. Cl. H04W 72/12

(52) U.S. Cl. 370/329

(57) ABSTRACT

Methods and systems for transmitting scheduling requests in an LTE Advanced system are disclosed. Scheduling requests may be superimposed on HARQ ACK/NACK by multiplying the HARQ ACK/NACK by a value. Alternatively, scheduling requests may be channel-coded and multiplexed with other uplink control information. Scheduling requests can also be superimposed on reference signals by multiplying a reference signal by a value or by modulating a reference signal with a cyclic shift. Scheduling requests may also be jointly coded with HARQ ACK/NACK prior to transmission. Alternatively, ACK/NACK responses may be transmitted on assigned ACK/NACK PUCCH resources for a negative scheduling request transmission and on assigned scheduling request PUCCH resources for a positive scheduling request. Various collision handling mechanisms are also disclosed.

### CROSS-REFERENCE TO RELATED APPLICATIONS

This application claims the benefit of U.S. Provisional Application No. 61/233,747, filed Aug. 13, 2009, and U.S. Provisional Application No. 61/356,250, filed Jun. 18, 2010, both of which are hereby incorporated by reference herein.

### BACKGROUND

In order to support higher data rate and spectrum efficiency, the Third Generation Partnership Project (3GPP) Long Term Evolution (LTE) system has been introduced into 3GPP Release 8 (R8). (LTE Release 8 may be referred to herein as LTE R8 or R8-LTE.) In LTE, transmissions on the uplink are performed using Single Carrier Frequency Division Multiple Access (SC-FDMA). In particular, the SC-FDMA used in the LTE uplink is based on Discrete Fourier Transform Spread Orthogonal Frequency Division Multiplexing (DFT-S-OFDM) technology. As used hereafter, the terms SC-FDMA and DFT-S-OFDM are used interchangeably.

In LTE, a wireless transmit/receive unit (WTRU), alternatively referred to as a user equipment (UE), transmits on the uplink using only a limited, contiguous set of assigned sub-carriers in a Frequency Division Multiple Access (FDMA) arrangement. For example, if the overall Orthogonal Frequency Division Multiplexing (OFDM) signal or system bandwidth in the uplink is composed of useful sub-carriers numbered 1 to 100, a first given WTRU may be assigned to transmit on sub-carriers 1-12, a second WTRU may be assigned to transmit on sub-carriers 13-24, and so on. While the different WTRUs may each transmit into only a subset of the available transmission bandwidth, an evolved Node-B (eNodeB) serving the WTRUs may receive the composite uplink signal across the entire transmission bandwidth.

LTE Advanced (which includes LTE Release 10 (R10) and may include future releases such as Release 11, also referred to herein as LTE-A, LTE R10, or R10-LTE) is an enhancement of the LTE standard that provides a fully-compliant 4G upgrade path for LTE and 3G networks. In LTE-A, carrier aggregation is supported, and, unlike in LTE, multiple carriers may be assigned to the uplink, downlink, or both.

In both LTE and LTE-A, there is a need for certain associated layer 1/layer 2 (L1/2) uplink control information (UCI) to support the uplink (UL) transmission, downlink (DL) transmission, scheduling, multiple-input multiple-output (MIMO), etc. In LTE, if a WTRU has not been assigned an uplink resource for UL transmission, such as a Physical UL Shared Channel (PUSCH), then the L1/2 UCI may be transmitted in a UL resource specially assigned for UL L1/2 control on a physical uplink control channel (PUCCH). What are needed in the art are systems and methods for transmitting UCI and other control signaling utilizing the capabilities available in an LTE-A system.

### SUMMARY

Methods and systems for transmitting uplink control information (UCI), in particular scheduling requests (SRs), in an LTE Advanced system are disclosed. Scheduling requests may be superimposed on HARQ ACK/NACK by multiplying the HARQ ACK/NACK by a value. Alternatively, scheduling requests may be channel-coded and multiplexed with other uplink control information. Scheduling requests may also be superimposed on or modulated with reference signals by multiplying a reference signal by a value or by modulating a reference signal with a cyclic shift. The cyclic shift may be derived from a resource assigned for transmission of HARQ ACK/NACK and SR on PUCCH. SR bits may also be jointly coded with HARQ ACK/NACK prior to transmission. Alternatively, ACK/NACK responses may be transmitted on the assigned ACK/NACK PUCCH resources for a negative scheduling request transmission or when a scheduling request is absent and on the assigned scheduling request PUCCH resources for a positive scheduling request or when a scheduling request is present. SR bits may also puncture HARQ ACK/NACK information in a PUCCH format 2 or DFT-S-OFDM subframe or the like.

To address collision handling, if there is no collision between HARQ ACK/NACK and channel state information (CSI) for a subframe, CSI may be transmitted on PUSCH without data (only CSI) or PUCCH, but if there is a collision between HARQ ACK/NACK and CSI for a subframe, only HARQ ACK/NACK may be transmitted for this subframe, while no CSI may be transmitted. CSI may be dropped in such embodiments. Alternatively, in the event of a collision between HARQ ACK/NACK and CSI for a subframe, both HARQ ACK/NACK and CSI may be transmitted on PUSCH without data or PUCCH. In another alternative, HARQ ACK/NACK may be transmitted on PUCCH format 2 or DFT-S-OFDM-based format and CSI may be transmitted on PUSCH without data simultaneously or on PUSCH with data if data is present. In the event of a collision between ACK/NACK and positive SR in a same subframe, a WTRU may be configured to drop ACK/NACK and transmit only SR. The WTRU may be configured to drop ACK/NACK only if the HARQ ACK/NACK payload size exceeds a threshold that may be provided via higher layer signaling by the network or predetermined These and additional aspects of the current disclosure are set forth in more detail below.

### BRIEF DESCRIPTION OF THE DRAWINGS

The following detailed description of disclosed embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 2 illustrates a non-limiting exemplary carrier aggregation and flexible bandwidth arrangement that may be used by some methods and systems for signaling uplink control information.

FIG. 3 illustrates a non-limiting exemplary mapping of UCI to subcarriers that may be used by some methods and systems for signaling uplink control information.

FIG. 4 illustrates a non-limiting exemplary method of superimposing a scheduling request on HARQ ACK/NACK.

FIG. 5 illustrates non-limiting exemplary system for channel-coding and multiplexed scheduling requests with other UCI.

FIG. 6 illustrates a non-limiting exemplary mapping of UCI to subcarriers that may be used by some methods and systems for signaling uplink control information.

FIG. 7 illustrates another non-limiting exemplary system for generating a PUCCH structure according to one embodiment.

FIG. 8 illustrates a non-limiting exemplary method of superimposing a scheduling request on a reference signal.

FIG. 9 illustrates a non-limiting exemplary method of modulating a reference signal in order to indicate a scheduling request.

FIG. 10 illustrates another non-limiting exemplary system for generating a PUCCH structure according to another embodiment.

FIG. 11 illustrates a non-limiting exemplary method of joint coding of a scheduling request with HARQ ACK/NACK according to one embodiment.

FIG. 12 illustrates another non-limiting exemplary method of joint coding of a scheduling request with HARQ ACK/NACK according to one embodiment.

### DETAILED DESCRIPTION OF ILLUSTRATIVE EMBODIMENTS

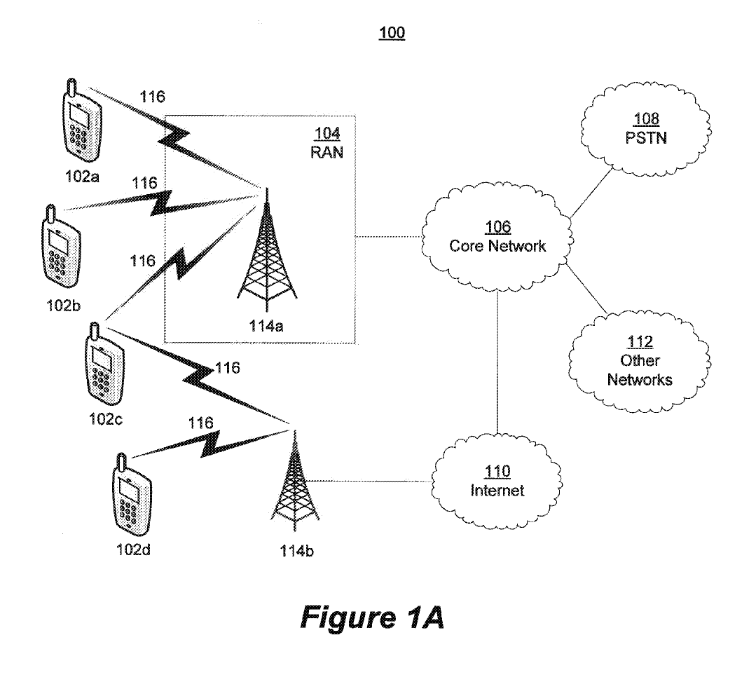

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

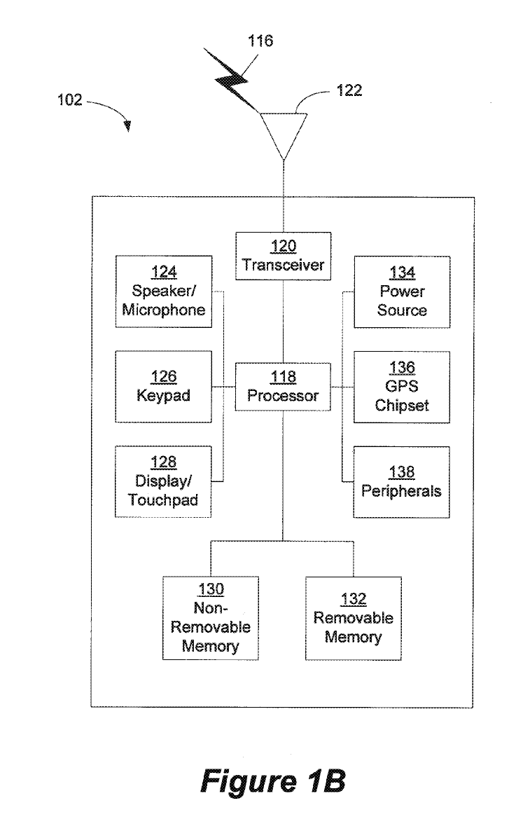

In LTE-A, carrier aggregation and support for flexible assignment of bandwidths may be available. LTE-A may support DL and/or UL transmission bandwidths in excess of 20 MHz, and more flexibility for usage of the available spectrum. For example, whereas R8 LTE may be limited to operation in symmetrical and paired FDD mode, e.g. DL and UL are both 10 MHz, or 20 MHz, or otherwise utilize equal transmission bandwidths, in some LTE-A embodiments, asymmetric configurations may be supported, such as 10 MHz DL paired with 5 MHz UL. In addition, composite aggregate transmission bandwidths may also be supported with LTE-A. For example, a DL may be configured with a first 20 MHz carrier plus a second 10 MHz carrier, and paired with an UL 20 MHz carrier and so on. Note that the composite aggregate transmission bandwidths may not necessarily be contiguous in the frequency domain, e.g. the first 10 MHz so-called component carrier in the above example could be spaced by 22.5 MHz in the DL band from the second 5 MHz DL component carrier. Alternatively, operation in contiguous aggregate transmission bandwidths may also be configured, e.g. a first DL component carrier of 15 MHz is aggregated with another 15 MHz DL component carrier and paired with a UL carrier of 20 MHz. Non-limiting examples of these different configurations for LTE-A carrier aggregation and support of flexible bandwidth arrangements are illustrated in FIG. 2.

In the LTE-R8 system UL direction, it may be desirable to transmit certain L1/2 control signaling (such as ACK/NACK, CQI, PMI, RI, etc.) in order to support UL transmission, DL transmission, scheduling, MIMO, etc. If a UE has not been assigned an uplink resource for UL data transmission, e.g., PUSCH, then the L1/2 uplink control information may be transmitted in a UL resource specifically assigned for UL L1/2 control on PUCCH. These PUCCH resources may be located at the edges of the total available component carrier bandwidth.

The following combinations of uplink control information (UCI) for ACK/NACK on PUCCH for LTE R8 FDD may be used:
HARQ-ACK using PUCCH format 1a or 1b,
HARQ-ACK and scheduling requests (SRs) using PUCCH format 1a or 1b, and
CQI/PMI or RI and HARQ-ACK using PUCCH format 2a or 2b for normal cyclic prefix and/or PUCCH format 2 for extended cyclic prefix.
   Uplink control information (UCI) in subframe n may be transmitted on PUCCH using format 1/1a/1b or 2/2a/2b if the UE is not transmitting on PUSCH in subframe n, or on PUSCH if the UE is transmitting on PUSCH in subframe n unless the PUSCH transmission corresponds to a Random Access Response Grant or a retransmission of the same transport block as part of a contention based random access procedure, in which case UCI may not be transmitted.

The time and frequency resources that may be used by a UE to report channel quality indicator (CQI), precoding matrix indicator (PMI), and rank indicator (RI) may be controlled by the eNodeB. CQI, PMI, and RI reporting may be periodic or aperiodic. A UE may transmit periodic CQI/PMI or RI reporting on PUCCH in subframes with no PUSCH allocation. A UE may transmit periodic CQI/PMI or RI reporting on PUSCH in subframes with PUSCH allocation, where the UE may use the same PUCCH-based periodic CQI/PMI or RI reporting format on PUSCH. The CQI transmissions on PUCCH and PUSCH for embodiments implementing various scheduling modes are summarized in Table 1.

TABLE 1
Physical Channels for Aperiodic or Periodic CQI reporting

| | Periodic CQI reporting | Aperiodic CQI |
|---|---|---|
| Scheduling Mode | channels | reporting channel |
| Frequency non-selective | PUCCH | |
| Frequency selective | PUCCH | PUSCH |

In some embodiments, both periodic and aperiodic reporting may occur in the same subframe. In such situations, the UE may only transmit an aperiodic report in that subframe.

A UE may be semi-statically configured by higher layers to periodically feed back different CQI, PMI, and RI on the PUCCH using the reporting modes given below in Table 2, which are described in more detail below.

TABLE 2
CQI and PMI Feedback Types for PUCCH reporting Modes

PMI Feedback Type

| | | No PMI | Single PMI |
|---|---|---|---|
| PUCCH CQI | Wideband | Mode 1-0 | Mode 1-1 |
| Feedback Type | (wideband CQI) | | |
| | UE Selected | Mode 2-0 | Mode 2-1 |
| | (subband CQI) | | |

For periodic reporting, a periodic CQI reporting mode may be indicated by the parameter cqi-FormatIndicatorPeriodic which may be configured by higher-layer signaling.

For the UE-selected subband CQI, a CQI report in a certain subframe may describe the channel quality in a particular part or in particular parts of the bandwidth described subsequently as bandwidth part (BP) or parts. The bandwidth parts may be indexed in the order of increasing frequency and non-increasing sizes starting at the lowest frequency.
There may be a total of N subbands for a system bandwidth given by N_{RB}^{DL} where └N_{RB}^{DL}/k┘ subbands are of size k. If ┌N_{RB}^{DL}/k┐−└N_{RB}^{DL}/k┘>0 then one of the subbands may be of size N_{RB}^{DL}−k·└N_{RB}^{DL}/k┘.
A bandwidth part j may be frequency-consecutive and consists of Nⱼ subbands where J bandwidth parts may span S or N_{RB}^{DL}. If J=1 then Nⱼ is ┌N_{RB}^{DL}/k/J┐. If J>1 then Nⱼ may be either ┌N_{RB}^{DL}/k/J┐ or ┌N_{RB}^{DL}/k/J┐−1, depending on N_{RB}^{DL}, k and J.
Each bandwidth part j, where 0≦j≦J−1, may be scanned in sequential order according to increasing frequency.
For UE selected subband feedback a single subband out of Nⱼ subbands of a bandwidth part may be selected along with a corresponding L-bit label where

L=┌log₂┌N_{RB}^{DL}/k/J┐┐.

Four CQI/PMI and RI reporting types with distinct periods and offsets may be supported for each PUCCH reporting mode:

Type 1 report may support CQI feedback for the UE selected sub-bands,

Type 2 report may support wideband CQI and PMI feedback,

Type 3 report may support RI feedback, and

Type 4 report may support wideband CQI.

In case of a collision between CQI/PMI/RI and ACK/NACK in a same subframe, CQI/PMI/RI may be dropped if the parameter simultaneousAckNackAndCQI provided by higher layers is set FALSE. CQI/PMI/RI may be multiplexed with ACK/NAK otherwise.

The following formats may be used for PUCCH reporting embodiments within this disclosure, and may be implemented according to 3GPP TS 36.213 “Physical Layer Procedures”, V.8.5.0., 2008-12 (referred to alternatively as “TS 36.213”):
Format 2 as defined in section 5.4.2 of TS 36.213 when CQI/PMI or RI report is not multiplexed with ACK/NAK,
Format 2a/2b as defined in section 5.4.2 of TS 36.213 when CQI/PMI or RI report is multiplexed with ACK/NAK for normal CP, and
Format 2 as defined in section 5.4.2 of TS 36.213 when CQI/PMI or RI report is multiplexed with ACK/NAK for extended CP

The CQI/PMI or RI report may be transmitted on the PUCCH resource n_{PUCCH}⁽²⁾ as defined in TS 36.213, where n_{PUCCH}⁽²⁾ is UE specific and configured by higher layers. In case of collision between CQI/PMI/RI and positive scheduling request (SR) in a same subframe, CQI/PMI/RI may be dropped.

An ACK/NACK transmission scheme based on Discrete Fourier Transform-Spread-Orthogonal Frequency Division Multiplex (DFT-S-OFDM) may be used for embodiments implementing carrier aggregation.

In an LTE-A system, UE uplink control information (UCI) may need to be sent to an eNodeB from the UE. In some embodiments, multiple carriers may be assigned to either UL, DL or both. LTE release-8 supports simultaneous transmission of SR and ACK/NACK information by using a SR resource instead of an ACK/NACK resource for carrying ACK/NACK information. This is possible because both SR and ACK/NACK formats may use the same PUCCH structure. In LTE-A, there may be multiple ACK/NACK transmission schemes to carry various payload sizes of ACK/NACK information bits (e.g., channel selection using PUCCH format 1b, PUCCH format 2, DFT-S-OFDM based format). However, an SR resource can carry only up to two-bit ACK/NACK information. Moreover, in LTE-A each UE may be limited to one scheduling request transmitted on PUCCH, and a single UE-specific UL CC may be configured semi-statically for carrying PUCCH ACK/NACK, SR, and periodic CSI from a UE.

Presented now are methods, systems, and means for implementing concurrent transmission of SR and the hybrid automatic repeat request (HARQ) acknowledgement/negative acknowledgement (ACK/NACK) in a single UE-specific UL component carrier.

In one embodiment, support for UCI transmission in implementations that use bandwidth extension (multi carriers), high order MIMO (e.g., 8×8), and/or coordinated multi-point transmission (COMP) may be provided by multiplexing UCI for periodic PUSCH using the modified format of an LTE-R8 PUSCH without data to carry high volume variable sizes of UCIs (e.g., SR, HARQ ACK/NACK, CQI, PMI, RI).

In such embodiments, a UE may use either of two types of PUSCH. In an embodiment, periodic PUSCH for UCI only (without data) may be used, while in other embodiments aperiodic PUSCH for UCI and data may be used. For embodiments where a UE needs to send UCI only without data, the PUCCH formats of LTE-R8 may be replaced with the PUSCH without data for LTE-A systems except for LTE-R8 compatible cases (e.g., only one component carrier (CC) assigned).

In some embodiments, an eNodeB may know when to expect HARQ ACK/NACK and CSI (CQI, PMI, RI) from a UE. In such embodiments, an eNodeB may assign appropriate size and location of a resource block (RB) for a UE depending on UCI types, HARQ ACK/NACK, CSI, or both. Note that the signaling of RB size and location may be done similarly to the signaling of phase rotation and orthogonal cover in LTE-R8.

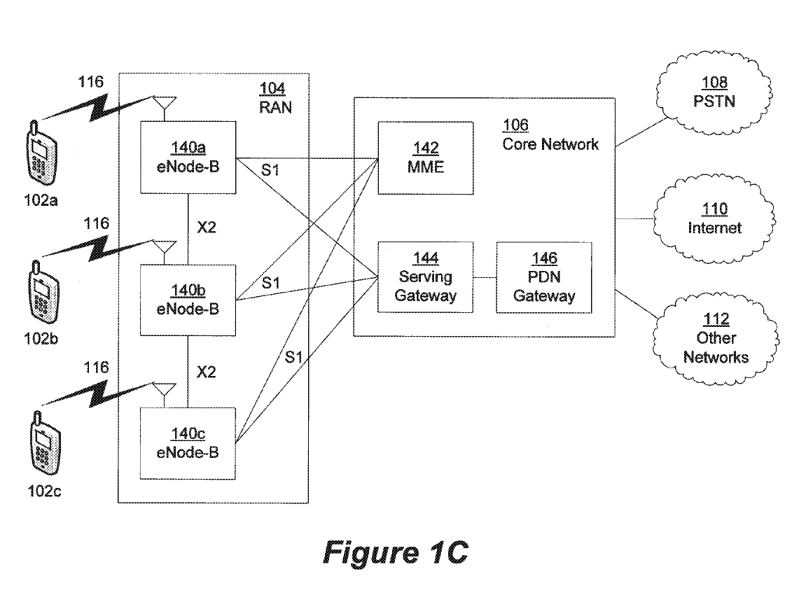

When a UE needs to transmit a scheduling request (SR) within periodic PUSCH control signaling, in one embodiment, the SR may be superimposed on the corresponding HARQ ACK/NACK which may be separated on the left and the right side of a reference signal (RS). For example, a HARQ ACK/NACK on the left side of an RS may be multiplied by 1, and a HARQ ACK/NACK on the right side of an RS may be multiplied by −1 if a SR is needed. As shown in FIG. 3, illustrating mapping 301 of UCI to subcarriers in two slots, PUSCH RS 310 of each slot may be flanked by HARQ ACK/NACK 320 on either side, which may be multiplied by a value in order to superimpose or otherwise integrate an SR into each instance of HARQ ACK/NACK 320. Also shown in mapping 301 is the mapping of rank indicator (RI) 330 into slot 0 and slot 1. The remaining area of mapping 301 may be occupied by data/CSI 340, which may be any other data and/or channel state information (CSI).

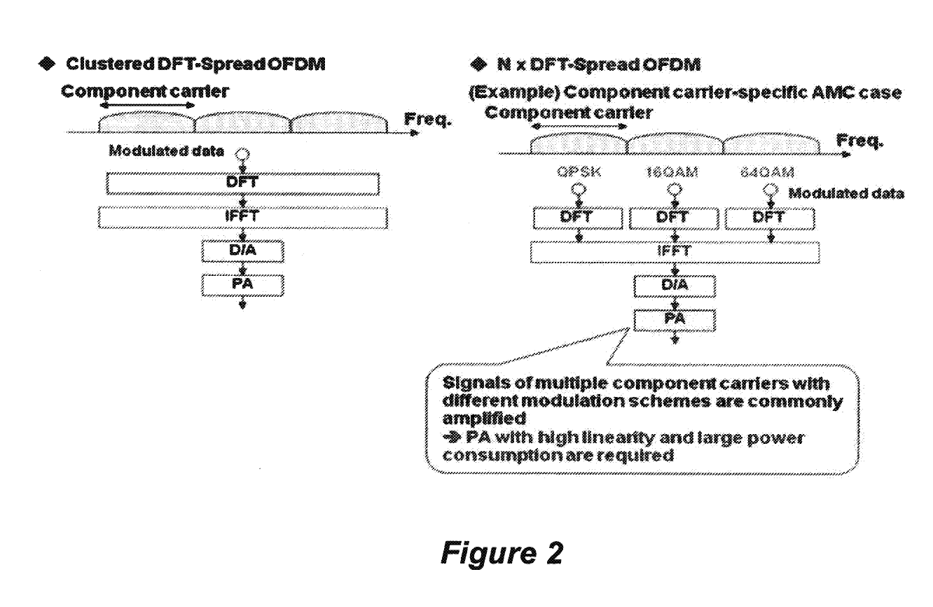

FIG. 4 illustrates method 400 of implementing such an embodiment. At block 410, it may be determined that an SR is to be transmitted by a UE. At block 420, one or more ACK/NACKs may be determined and modified as described above, for example, by multiplying each ACK/NACK by a value such as 1 or −1. At block 430, the modified ACK/NACK(s) may be mapped onto subcarriers for transmission from the UE.

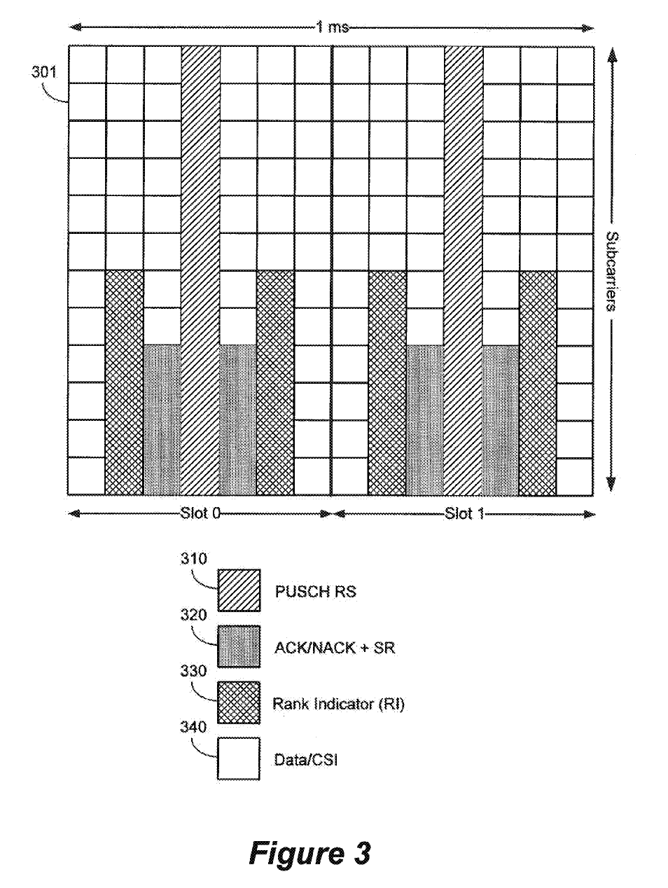

In an alternate embodiment, an SR bit may be channel-coded and multiplexed with other UCIs as illustrated in FIG. 5. As seen in FIG. 5, scheduling request 521 may be multiplexed with other UCI, such as RI 522, HARQ ACK/NACK 523, and CQI/PMI 524. Each type of UCI may be channel coded by channel coders 540a-d, and interleaved by channel interleaver 550 in preparation for transmission to an eNodeB. HARQ ACK/NACK and RI symbols may be multiplexed onto uplink resource elements in the manner used in LTE Rel-8. SR mapping may be accomplished by puncturing the CQI/PMI symbols irrespective of whether SR is actually present in a given subframe. This is to ensure that the SR can be decoded with a relatively low probability of error similar to that of HARQ ACK/NACK. The number of resource elements used for SR is based on the MCS assigned for PUSCH and an offset parameter Δ_{offset}^{SR} which is configured by higher layer signaling. This is to facilitate the use of different code rates for SR. Alternatively an SR bit may be jointly encoded with other UCI bits. In this case one or more SR bits and other UCI bits (or part of other UCI bits) may be channel coded by a common channel coder.

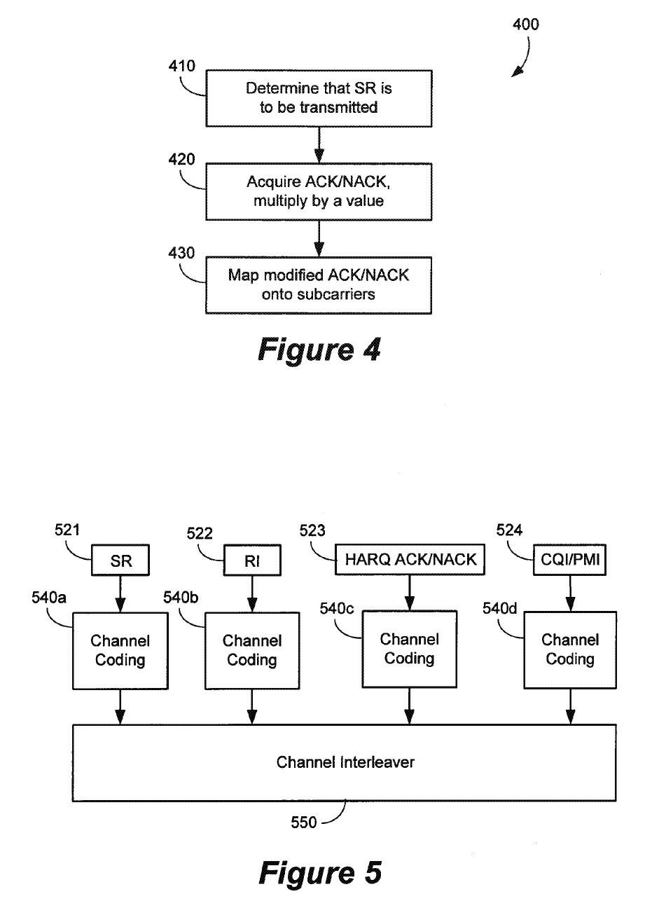

For example, as shown in FIG. 6 illustrating mapping 601 of UCI to subcarriers in two slots, PUSCH RS 610 of each slot may be flanked by HARQ ACK/NACK 620 on either side. In this embodiment, instead of multiplying HARQ ACK/NACK 620 by a value in order to superimpose an SR into each instance of HARQ ACK/NACK 620, SR 650 is indicated by puncturing the CQI/PMI symbols as shown in FIG. 6. Also shown in mapping 601 is the mapping of rank indicator (RI) 630 into slot 0 and slot 1. The remaining area of mapping 601 may be occupied by data/CSI 640, which may be any other data and/or CSI.

In another alternative, uplink control information for PUCCH may be multiplexed similar to LTE-R8 PUCCH format 2 to carry SR and HARQ ACK/NACK. PUSCH format without data may be used to carry CSI (CQI, PMI, RI). By using LTE-R8 PUCCH format 2 to carry SR and HARQ ACK/NACK, LTE-A systems may take advantage of the available bandwidth extension (i.e., multiple carriers). In such embodiments, where multiplexing may be implemented as shown FIG. 5, the HARQ ACK/NACKs may replace CQI/PMI/RI in LTE R8. Note that in many LTE-A embodiments, LTE-R8 PUCCH will be used only for LTE compatible case (e.g. only one CC assigned). In addition, the SR in such LTE-A embodiments can be formatted and sent using any of several implementations.

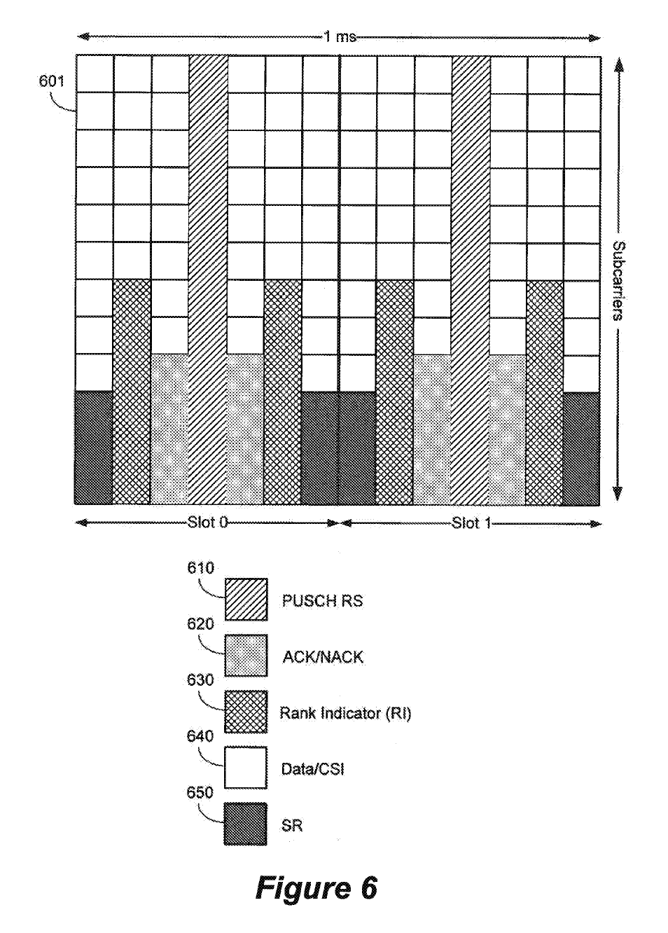

In one embodiment, an SR may be superimposed on the reference signals. For example if an SR is positive, the reference signals on the 5^{th} and 12^{th} OFDM symbols may be multiplied by −1. FIG. 7 illustrates non-limiting exemplary system 700 for generating PUCCH structure 701 (represented by the concatenation of slots 701a and 701b) for a DFT-S-OFDM based PUCCH transmission with SF=5 according to an embodiment of the present disclosure. As seen in FIG. 7, SR 710 may be represented by multiplying RS 715 by a value, such as −1. RS 715 may be the 5^{th} OFDM symbol in PUCCH structure 701. Likewise, SR 720 may be represented by multiplying RS 725 by a value, such as −1. RS 725 may be the 12^{th} OFDM symbol in PUCCH structure 701. RS 731, the 1^{st} OFDM symbol in PUCCH structure 701 (in slot 701a), and RS 732, the 7^{th} OFDM symbol in PUCCH structure 701 (in slot 701b), may not be affected in this embodiment. Alternatively, RSs 731 and/or 732 may be multiplied by a value to indicate an SR or other information instead of, or in addition to, manipulating RSs 715 and 725. This embodiment may be a preferred approach in low Doppler scenarios. However, this embodiment may not be preferred for extended cyclic prefix mode because there is only a single reference symbol per slot.

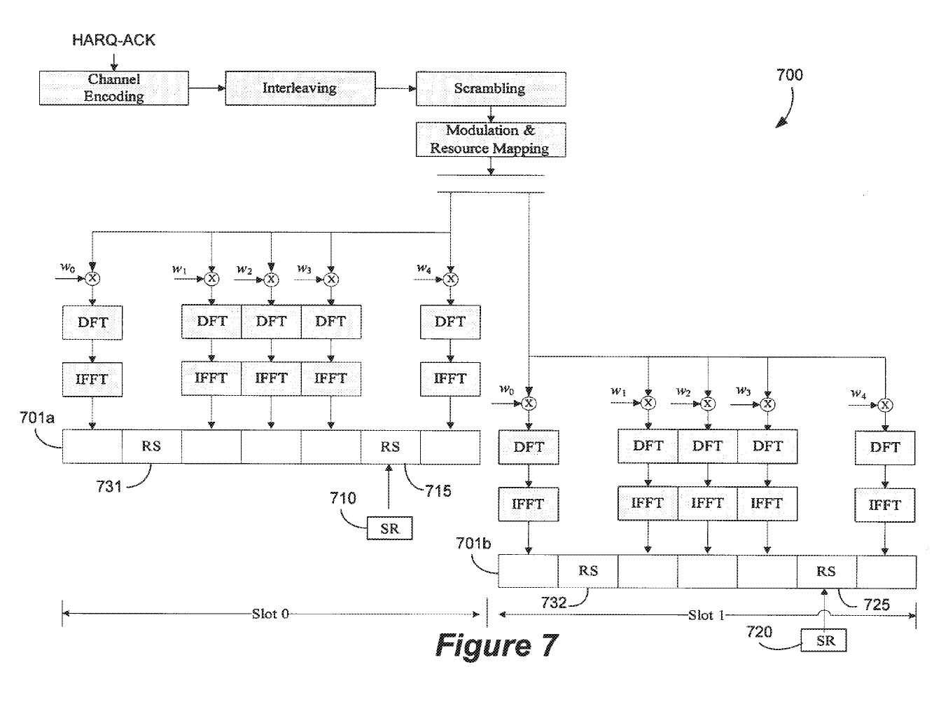

FIG. 8 illustrates method 800 of implementing such an embodiment. At block 810, it may be determined that an SR is to be transmitted by a UE, or that SR is positive. At block 820, one or more RSs may be determined and modified as described above, for example, by multiplying each RS by a value such as 1 or −1. At block 830, the modified RS(s) may be mapped onto subcarriers for transmission from the UE.

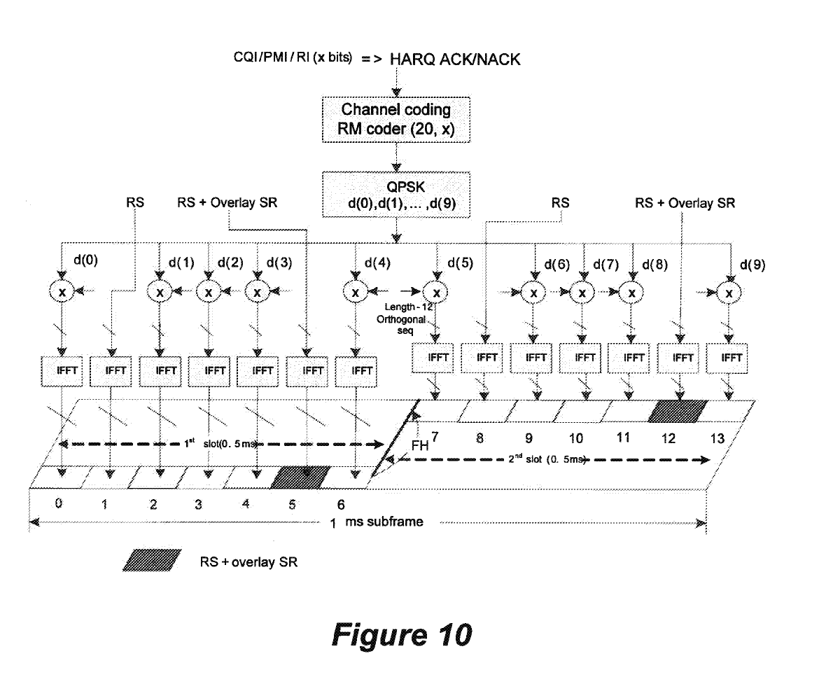

In such embodiments, referring now to FIG. 10, at the UE the HARQ-ACK information may be first channel coded using Reed-Muller or convolutional code with input bit sequence a₀′, a₁′, a₂′, a₃′, . . . , a_{A′-1}′ and output bit sequence b₀′, b₁′, b₂′, b₃′, . . . , b_{B′-1}′, where b_{B′=}20 for PUCCH format 2 or B′=48 for DFT-S-OFDM-based PUCCH structure. Other values of B′ such as B′=96 may be used for other variants of a DFT-S-OFDM-based PUCCH structure. Denoting the scheduling request bit by a₀″, each positive SR may be encoded as a binary ‘0’ and each negative SR (i.e., where no scheduling request is needed) may be encoded as a binary ‘1’. Alternatively, each positive SR can be encoded as a binary ‘1’ and each negative SR can be encoded as a binary ‘0’. The output of the channel coding block may be given by b₀, b₁, b₂, b₃, . . . , b_{B-1}, where bᵢ=bᵢ′, i=0, . . . , B′−1 and b_{B′}=a₀″ with B=(B′+1).

The block of encoded bits may be interleaved, scrambled with a UE-specific scrambling sequence, and modulated resulting in a block of complex-valued modulation symbols d(0), . . . ,

$$d ( ⌊ \frac{B}{2} ⌋ )$$

for the ACK/NACK payload. A single BPSK modulation symbol

$$d ( ⌊ \frac{B}{2} ⌋ + 1 )$$

carrying a SR information bit may be used in the generation of one of the reference-signals for PUCCH format 2 or a DFT-S-OFDM based PUCCH structure.

In another embodiment of the present invention, one of the reference symbols (e.g., RS 715, 725, 731 or 732) may be modulated with an alternative cyclic shift. For example, a UE may be configured with a pair of orthogonal sequences, where the two sequences are implicitly determined from the same Control Channel Element (CCE) of the Physical Downlink Control Channel (PDCCH). There may be a one-to-one mapping between one of the assigned sequences and the positive SR and a one-to-one mapping between the other assigned sequence and the negative SR. In other words, the UE may first determine the resources for concurrent transmission of HARQ-ACK and SR on PUCCH by a resource index (e.g., n_{PUCCH}⁽¹⁾). Then the pair of cyclic shifts (e.g., αᵢ, α₂) may be determined based on the assigned resource. These shifts may then be used to modulate a reference symbol, indicating a negative or positive SR.

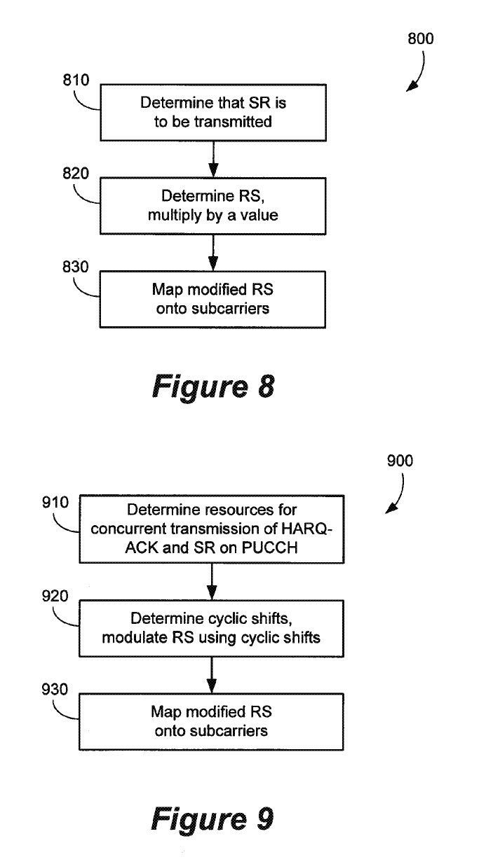

FIG. 9 illustrates method 900 of implementing such an embodiment. At block 910, a UE may determine the resources for concurrent transmission of HARQ-ACK and SR on PUCCH. Based on the determined assigned resource, at block 920, the UE may determine a pair of cyclic shifts and may modulate one or more RSs using the determined cyclic shift. At block 930, the UE may map the modified RS(s) onto subcarriers for transmission.

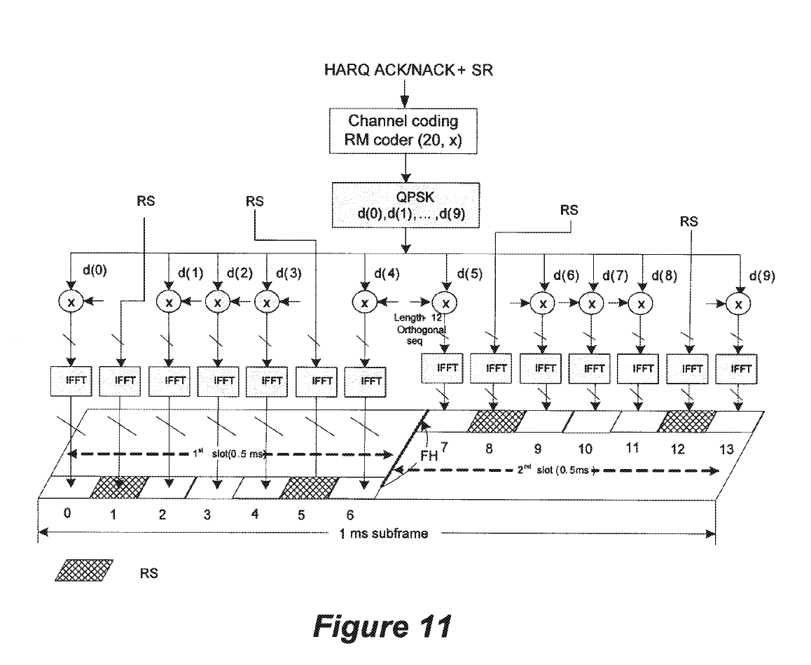

In another embodiment, and referring now to FIG. 11, an SR bit may be jointly coded with HARQ ACK/NACK (but at a known bit position, e.g., the first bit) prior to transmission. Accordingly, at the UE, the uncoded HARQ-ACK information denoted by a₀′, a₁′, a₂′, a₃′, . . . , a_{A′-1}′ may be multiplexed with the SR bit to yield the sequence a₀′, a₁′, a₂′, a₃′, . . . , a_{A′-1}′ as follows: aᵢ=aᵢ′, i=0, . . . , A′−1 and a_{A′}=a₀″ with A=(A′+1). The sequence a₀, a₁, a₂, a₃, . . . , a_{A-1} may be channel encoded using Reed-Muller or convolutional code to yield the output bit sequence b₀, b₁, b₂, b₃, . . . , b_{B-1} where B=20 for PUCCH format 2 or B=48 for DFT-S-OFDM based PUCCH structure. This embodiment may be a preferred approach in high Doppler scenarios, and may be the preferred embodiment for implementations using extended cyclic prefix mode.

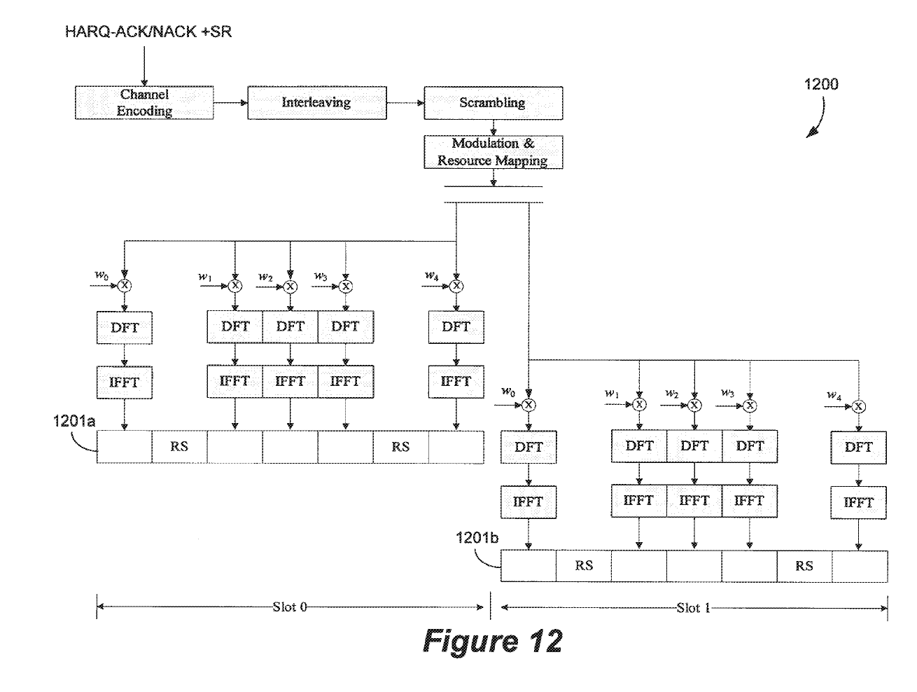

FIG. 12 provides another illustration of a system for jointly encoding an SR bit with HARQ ACK/NACK to generate PUCCH structure 1201 (represented by the concatenation of slots 1201a and 1201b) for a DFT-S-OFDM based PUCCH transmission according to an embodiment of the present disclosure. As seen in FIG. 12, SR and HARQ ACK/NACK may be jointly coded and mapped to OFDM symbols that are not occupied by RS.

In another embodiment of the present invention, where joint coding with the Reed-Muller code is used, where the codewords used may be a linear combination of the A basis sequences denoted by M_{i,n}, the SR bit may be spread by the most reliable basis sequence that could maximize the frequency diversity gain. For example, the basis sequence candidate that could potentially disperse the SR information-coded bit more evenly across the subframe is the one selected for use in encoding the SR bit. In this embodiment, the encoded bit sequence of length B at the output of the channel encoder may be given by:

$${b}_{i} = {a}_{m} \cdot {M}_{i , m} + {\sum }_{n = 0 , n \neq m}^{A - 1} {a}_{n} \cdot {M}_{i , n}$$

$$i = 0 , 1 , … , B - 1$$

where aₘ denotes the SR bit.

A non-limiting exemplary basis sequence for RM(20,k) for encoding the SR information bit is M_{i,1} shown in Table 3 below.

TABLE 3
Exemplary basis sequence for encoding an SR bit

| i | M_{i,0} | M_{i,1} | M_{i,2} | M_{i,3} | M_{i,4} | M_{i,5} | M_{i,6} | M_{i,7} | M_{i,8} | M_{i,9} | M_{i,10} | M_{i,11} | M_{i,12} |
|---|---|---|---|---|---|---|---|---|---|---|---|---|---|
| 0 | 1 | 1 | 0 | 0 | 0 | 0 | 0 | 0 | 0 | 0 | 1 | 1 | 0 |
| 1 | 1 | 1 | 1 | 0 | 0 | 0 | 0 | 0 | 0 | 1 | 1 | 1 | 0 |
| 2 | 1 | 0 | 0 | 1 | 0 | 0 | 1 | 0 | 1 | 1 | 1 | 1 | 1 |
| 3 | 1 | 0 | 1 | 1 | 0 | 0 | 0 | 0 | 1 | 0 | 1 | 1 | 1 |
| 4 | 1 | 1 | 1 | 1 | 0 | 0 | 0 | 1 | 0 | 0 | 1 | 1 | 1 |
| 5 | 1 | 1 | 0 | 0 | 1 | 0 | 1 | 1 | 1 | 0 | 1 | 1 | 1 |
| 6 | 1 | 0 | 1 | 0 | 1 | 0 | 1 | 0 | 1 | 1 | 1 | 1 | 1 |
| 7 | 1 | 0 | 0 | 1 | 1 | 0 | 0 | 1 | 1 | 0 | 1 | 1 | 1 |
| 8 | 1 | 1 | 0 | 1 | 1 | 0 | 0 | 1 | 0 | 1 | 1 | 1 | 1 |
| 9 | 1 | 0 | 1 | 1 | 1 | 0 | 1 | 0 | 0 | 1 | 1 | 1 | 1 |
| 10 | 1 | 0 | 1 | 0 | 0 | 1 | 1 | 1 | 0 | 1 | 1 | 1 | 1 |
| 11 | 1 | 1 | 1 | 0 | 0 | 1 | 1 | 0 | 1 | 0 | 1 | 1 | 1 |
| 12 | 1 | 0 | 0 | 1 | 0 | 1 | 0 | 1 | 1 | 1 | 1 | 1 | 1 |
| 13 | 1 | 1 | 0 | 1 | 0 | 1 | 0 | 1 | 0 | 1 | 1 | 1 | 1 |
| 14 | 1 | 0 | 0 | 0 | 1 | 1 | 0 | 1 | 0 | 0 | 1 | 0 | 1 |
| 15 | 1 | 1 | 0 | 0 | 1 | 1 | 1 | 1 | 0 | 1 | 1 | 0 | 1 |
| 16 | 1 | 1 | 1 | 0 | 1 | 1 | 1 | 0 | 0 | 1 | 0 | 1 | 1 |
| 17 | 1 | 0 | 0 | 1 | 1 | 1 | 0 | 0 | 1 | 0 | 0 | 1 | 1 |
| 18 | 1 | 1 | 0 | 1 | 1 | 1 | 1 | 1 | 0 | 0 | 0 | 0 | 0 |
| 19 | 1 | 0 | 0 | 0 | 0 | 1 | 1 | 0 | 0 | 0 | 0 | 0 | 0 |

In an alternative embodiment, which may be used in the event that a PUCCH structure is available that allows for multiple ACK/NACK transmission based on a PUCCH format 1 structure, a UE may transmit the ACK/NACK responses on its assigned ACK/NACK PUCCH resource for a negative SR transmission and on its assigned SR PUCCH resource for a positive SR. In this embodiment the PUCCH format used may be a new PUCCH format different than those used in LTE R8.

In yet another alternative, an SR bit may puncture the encoded HARQ-ACK sequence. At a UE, the HARQ-ACK information may be channel coded using Reed-Muller or convolutional code with input bit sequence a₀′, a₁′, a₂′, a₃′, . . . , a_{A′-1}′, and output bit sequence b₀′, b₁′, b₂′, b₃′, . . . , b_{B′-1}′, where B′=20 for PUCCH format 2 or B′=48 for DFT-S-OFDM based PUCCH structure. The scheduling request bit may be denoted by a₀″. The output of this channel coding block may be denoted by b₀, b₁, b₂, b₃, . . . , b_{B-1}, where bᵢ=bᵢ′, i=0, . . . , B′−1, where i≠j, and bⱼ=a₀″. Note that j may be the index of the bit at the output of the channel coding block that is overwritten by the SR bit.

According to yet another embodiment of the present invention, the puncturing can be performed at the symbol-level such that the binary phase-shift keying (BPSK) modulated SR symbol, punctures one of the QPSK modulated ACK/NACK symbols. In still another embodiment, some out of all phase rotations and/or additional RB may be reserved for use for SR in PUCCH format 1 of LTE-R8 by adding decoding complexity.

For embodiments that use LTE-R8 PUCCH format 2 to carry SR and HARQ ACK/NACK (including, but not limited to, the embodiments discussed in regard to FIGS. 7-11), CSI may be transmitted in any one of several ways. In an embodiment, if there is no collision between HARQ ACK/NACK and CSI for a subframe, CSI may be transmitted on PUSCH without data (i.e., only CSI), but if there is a collision between HARQ ACK/NACK and CSI for a subframe, only HARQ ACK/NACK may be transmitted for this subframe (i.e., no CSI will be transmitted). In an alternative embodiment, both HARQ ACK/NACK and CSI will be transmitted on PUSCH without data, for example as described above in regard to FIGS. 3-6. In another embodiment, HARQ ACK/NACK may be transmitted on PUCCH format 2 or DFT-S-OFDM-based PUCCH format while CSI may be transmitted simultaneously on PUSCH without data.

In some embodiments, when a collision between ACK/NACK and a positive SR occurs in a same subframe, the UE may be configured to drop ACK/NACK and only transmit SR. In such embodiments, the parameter SimultaneousAckNackAndSR provided by higher layers may determine if a UE is configured to support the simultaneous or concurrent transmission of ACK/NACK and SR in a same subframe. In this case, a new RRC information element (IE) (e.g., SchedulingRequestConfig-Rel10) may be used to enable signaling the parameter SimultaneousAckNackAndSR. A non-limiting example of such an RRC IE is provided below.

-- ASN1START

| | | |
|---|---|---|
| SchedulingRequestConfig-Rel10 | ::= | CHOICE { |
| release | | NULL, |

| | |
|---|---|
| setup | SEQUENCE { |

| | |
|---|---|
| sr-PUCCH-ResourceIndex | INTEGER (0..2047), |
| sr-ConfigIndex | INTEGER (0..155), |
| dsr-TransMax | ENUMERATED { |
| | n4, n8, n16, n32, n64, spare3, spare2, |
| spare1} | |
| simultaneousAckNackAndSR | BOOLEAN |
| } | |
| } | |
| -- ASNlSTOP | |

In an alternative embodiment, a UE may be configured to drop ACK/NACK whenever the HARQ-ACK payload size exceeds a predetermined value or threshold. Noting that the HARQ-ACK payload size may be a function of configured component carriers (CCs) and transmission modes, based on this scheme, the UE may implicitly know when to drop ACK/NACK information once it is configured by a higher layer regarding the number of CCs and the transmission mode on each CC. Such higher layer configuration may be provided by an eNodeB or other network element.

Examples of embodiments described herein include, but are not limited to, a method for, or a WTRU configured for, transmitting uplink control information comprising determining, at a wireless transmit and receive unit (WTRU), that a scheduling request is to be transmitted to a base station, superimposing the scheduling request on a reference signal, and transmitting the reference signal to the base station. Superimposing the scheduling request on the reference signal may be accomplished by multiplying the reference signal by a value. The value may be any value, including 1 or −1. Transmitting the reference signal to the base station may comprise constructing a subframe comprising the reference signal and transmitting the subframe. The subframe may be constructed in PUCCH format 2 and may also include HARQ ACK/NACK data. Two or more scheduling requests may be superimposed on two or more reference signals. When two reference signals are used, a first reference signal of the two reference signals may be a fifth OFDM symbol in a subframe and a second reference signal of the two reference signals may be the twelfth OFDM symbol in a subframe. In some embodiments, a second subframe in PUSCH format comprising channel state information may be transmitted.

Superimposing the scheduling request on the reference signal may also be accomplished by modulating the reference signal with a cyclic shift. The cyclic shift may be determined based on resources assigned for PUCCH transmission. Alternatively, a binary phase shift keying (BPSK) modulation symbol may be generated and used to generate the reference signal. In any of these embodiments, the reference signal may be transmitted as a DFT-S-OFDM transmission, and the base station may be an LTE eNodeB.

Other embodiments include, but are not limited to, a method for, or a WTRU configured for, transmitting uplink control information comprising determining, at a wireless transmit and receive unit (WTRU), that a scheduling request is to be transmitted to a base station, jointly encoding the scheduling request with HARQ ACK/NACK, and transmitting the encoded HARQ ACK/NACK to the base station. The scheduling request may be encoded in the HARQ ACK/NACK at a predetermined bit position.

Also contemplated is a method for, or a WTRU configured for, transmitting uplink control information comprising determining, at a wireless transmit and receive unit (WTRU), that a positive scheduling request is to be transmitted to a base station, transmitting the positive scheduling request to the base station on an assigned scheduling request PUCCH resource, determining, at the WTRU, that a negative scheduling request is to be transmitted to the base station, and transmitting the negative scheduling request to the base station on an assigned ACK/NACK PUCCH resource.

Further contemplated is a method for, or a WTRU configured for, transmitting uplink control information comprising determining, at a wireless transmit and receive unit (WTRU), that a scheduling request is to be transmitted to a base station, puncturing a HARQ ACK/NACK sequence with the scheduling request, and transmitting the punctured HARQ ACK/NACK sequence to the base station. In one embodiment, the scheduling request may be a BPSK modulated symbol and the HARQ ACK/NACK sequence may comprise QPSK modulated symbols, and wherein puncturing comprises the BPSK modulated symbol puncturing one of the QPSK modulated symbols.

Also contemplated is a method for, or a WTRU configured for, transmitting uplink control information comprising a determination that an ACK/NACK and a positive scheduling request are to be transmitted in the same subframe, and dropping the ACK/NACK and transmitting the positive scheduling request. This may be accomplished in part by checking a parameter to determine whether a WTRU is configured to transmit ACK/NACK and a positive scheduling request concurrently.

Further contemplated is a method for, or a WTRU configured for, transmitting uplink control information comprising determining that an ACK/NACK and a positive scheduling request are to be transmitted in the same subframe, determining that the ACK/NACK payload size exceeds a predetermined threshold, and dropping the ACK/NACK and transmitting the positive scheduling request based on the determination of the ACK/NACK payload size. The threshold may be provided by the network to the UE via higher layer signaling.

Also contemplated is a method for, or a WTRU configured for, transmitting uplink control information comprising determining that there is no collision between HARQ ACK/NACK and CSI for a particular subframe, and transmitting CSI on PUSCH without data (only CSI). If there is a collision between HARQ ACK/NACK and CSI for a particular subframe, HARQ ACK/NACK may be transmitted in the particular subframe and no CSI may be transmitted. Alternatively, both HARQ ACK/NACK and CSI may be transmitted on PUSCH without data. In another alternative, HARQ ACK/NACK may be transmitted on PUCCH format 2 and CSI on PUSCH without data simultaneously.

Further contemplated is a method for, or a WTRU configured for, transmitting uplink control information comprising determining, at a wireless transmit and receive unit (WTRU), that a scheduling request is to be transmitted to a base station, superimposing the scheduling request on HARQ ACK/NACK information, and transmitting the modified HARQ ACK/NACK. In an alternative, a scheduling request bit may be channel-coded and multiplexed with other UCI.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for transmitting uplink control information comprising:
determining, at a wireless transmit and receive unit (WTRU), that a scheduling request is to be transmitted to a base station;
determining uplink control information (UCI); and
concurrently transmitting the UCI and the scheduling request to the base station.

2. The method of claim 1, wherein concurrently transmitting the UCI and the scheduling request comprises superimposing the scheduling request on a reference signal and transmitting the reference signal and the UCI to the base station.

3. The method of claim 2, wherein superimposing the scheduling request on the reference signal comprises multiplying the reference signal by a value.

4. The method of claim 2, wherein superimposing the scheduling request on the reference signal comprises superimposing the scheduling request on two reference signals.

5. The method of claim 2, wherein superimposing the scheduling request on the reference signal comprises modulating the reference signal with a cyclic shift.

6. The method of claim 5, wherein the cyclic shift is determined based on resources assigned for PUCCH transmission.

7. The method of claim 1, wherein concurrently transmitting the UCI and the scheduling request comprises jointly coding HARQ ACK/NACK with the scheduling request.

8. The method of claim 7, wherein the HARQ ACK/NACK is jointly coded with the scheduling request at a predetermined bit position.

9. The method of claim 1, wherein concurrently transmitting the UCI and the scheduling request comprises superimposing the scheduling request on HARQ ACK/NACK and transmitting the HARQ ACK/NACK to the base station.

10. The method of claim 9, wherein superimposing the scheduling request on the HARQ ACK/NACK comprises multiplying the HARQ ACK/NACK by a value.

11. A wireless transmit and receive unit (WTRU) configured to transmit uplink control information, comprising:
a processor configured to:
determine that a scheduling request is to be transmitted to a base station, and
determine uplink control information (UCI); and
a transceiver configured to:
concurrently transmit the UCI and the scheduling request to the base station

12. The WTRU of claim 11, wherein the processor is further configured to superimpose the scheduling request on a reference signal, and wherein the transceiver is further configured to transmit the reference signal and the UCI to the base station.

13. The WTRU of claim 12, wherein the processor is configured to superimpose the scheduling request on the reference signal by multiplying the reference signal by a value.

14. The WTRU of claim 12, wherein the processor is configured to superimpose the scheduling request on the reference signal by superimposing the scheduling request on two reference signals.

15. The WTRU of claim 12, wherein the processor is configured to superimpose the scheduling request on the reference signal by modulating the reference signal with a cyclic shift.

16. The WTRU of claim 15, wherein the processor is further configured to determine the cyclic shift based on resources assigned for PUCCH transmission.

17. The WTRU of claim 11, wherein the processor is further configured to jointly code HARQ ACK/NACK with the scheduling request.

18. The WTRU of claim 17, wherein the processor is further configured to jointly code the HARQ ACK/NACK with the scheduling request at a predetermined bit position.

19. The WTRU of claim 11, wherein the processor is further configured to superimpose the scheduling request on HARQ ACK/NACK, and wherein the transceiver is further configured to transmit the HARQ ACK/NACK to the base station.

20. The WTRU of claim 19, wherein the processor is configured to superimpose the scheduling request on the HARQ ACK/NACK by multiplying the HARQ ACK/NACK by a value.
